(19) United States
(12) Patent Application Publication
(10) Pub. No.: US 2016/0320474 A1
(43) Pub. Date: Nov. 3, 2016

(54) TRANSDUCER HAVING SURFACE MOUNTED ELEMENTS AND ASSOCIATED METHODS

(71) Applicant: NAVICO HOLDING AS, Egersund (NO)

(72) Inventors: Alan Proctor, Owasso, OK (US); David Parks, Tulsa, OK (US)

(21) Appl. No.: 14/702,121

(22) Filed: May 1, 2015

(51) Int. Cl. G01S 7/521; G01S 15/08; G01S 15/89

(52) U.S. Cl. CPC G01S 7/521; G01S 15/89; G01S 15/08

(57) ABSTRACT

Various transducer assemblies, sonar systems, and associated methods are provided herein. In one embodiment, a method for manufacturing a transducer assembly is provided. The method may comprise placing one or more transducer elements onto a circuit board using a surface mount pick-and-place machine, and affixing the one or more transducer elements to the circuit board. Each transducer element is operatively connected to traces on the circuit board and each transducer element is configured to receive sonar returns from an underwater environment.

### FIELD OF THE INVENTION

Embodiments of the present invention relate generally to sonar systems and, more particularly, to sonar systems, assemblies, and associated methods for manufacturing and utilizing transducers having elements surface mounted on, for example, a printed circuit board (PCB).

### BACKGROUND OF THE INVENTION

Sonar (SOund Navigation And Ranging) has long been used to detect waterborne or underwater objects. For example, sonar devices may be used to determine depth and bottom topography, detect fish, locate wreckage, etc. In this regard, due to the extreme limits to visibility underwater, sonar is typically the most accurate way to locate objects underwater. Sonar transducer elements, or simply transducers, may convert electrical energy into sound or vibrations at a particular frequency. A sonar sound beam is transmitted into and through the water and is reflected from objects it encounters. The transducer may receive the reflected sound (the “sonar returns”) and convert the sound energy into electrical energy. Based on the known speed of sound, it is possible to determine the distance to and/or location of the waterborne or underwater objects. The sonar return signals can also be processed to be displayed, giving the user a “picture” or image of the underwater environment.

Some conventional sonar systems include ceramic crystal elements that are mounted within a housing. Often, each crystal is physically separate and shielding is used to focus the emitted or received sonar signals. Such crystals have to be individually positioned within the housing, making production of the resulting transducer assembly timing consuming and prone to inaccuracies, such as due to positioning and wiring. Through applied effort, ingenuity, and innovation, many of these identified problems have been solved by developing solutions that are included in embodiments of the present invention, many examples of which are described in detail herein.

### BRIEF SUMMARY

In general, embodiments of the present invention provided herein include sonar systems, transducer assemblies, methods, and associated methods and systems for manufacturing and utilizing a transducer assembly having surface mounted transducer elements. For example, surface mount technology may be used to place and solder one or more transducer elements (e.g., piezoelectric sensors) to a printed circuit board (PCB) with the precise and accurate placement required for ultrasonic and/or acoustic phased arrays. This method allows for production volumes of transducer assemblies to be readily fabricated. In some embodiments, signal processing components are mounted to the same PCB as the one or more transducer elements.

According to one aspect of the present invention, a method for manufacturing a transducer assembly is provided. In one embodiment, the method comprises etching traces to a circuit board; placing one or more transducer elements onto the circuit board using a surface mount pick-and-place machine; and affixing the one or more transducer elements to the circuit board. Each transducer element is operatively connected to the traces. Also, each transducer element is configured to receive sonar returns form an underwater environment.

In various embodiments, affixing of the one or more transducer elements to the circuit board is accomplished by a reflow oven. In some embodiments, each of the transducer elements are 150 mm by 100 mm or smaller. In various embodiments, placing each of the one or more transducer elements onto the circuit board using the surface mount pick-and-place machine comprises providing a tape reel of transducer elements to the surface mount pick-and-place machine; removing a transducer element from the tape reel using a component placement mechanism of the surface mount pick-and-place machine; and placing the transducer element onto the PCB using the component placement mechanism of the surface mount pick-and-place machine such that terminals of the transducer element rest on pads of the PCB. In some embodiments, to remove the transducer element from the tape reel, the component placement mechanism applies suction to the transducer element and to place the transducer element onto the PCB the component placement mechanism releases the suction. In various embodiments, each of the transducer elements is placed on the PCB in accordance with a specified x, y, z position. In some embodiments, the one or more transducer elements are placed on the PCB to form one line or more than one parallel lines in order to approximate the shape or beam pattern characteristics of a single ceramic element. In various embodiments, the traces comprise one or more sets of traces and each transducer element is affixed to one or more pads such that each transducer element is in electrical communication with at least one set of traces. In some embodiments, affixing the one or more transducer elements to the circuit board comprises affixing the one or more transducer elements to the printed circuit board in one or more diamond shapes. In some embodiments, affixing the one or more transducer elements to the printed circuit board comprises affixing the one or more transducer elements in 16 diamond shapes positioned such that a central axis of each diamond is substantially aligned with the central axis of each of the other diamonds. In various embodiments, the printed circuit board is a flexible printed circuit board. In some embodiments, each transducer element is electrically connected to individually receive the sonar returns.

According to another aspect of the present invention, a transducer assembly is provided. In various embodiments, the transducer assembly comprises a housing mountable to a watercraft; a printed circuit board (a) comprising traces, (b) having one or more transducer elements mounted thereto, and (c) positioned within the housing. The printed circuit board is prepared by a process comprising placing one or more transducer elements onto the circuit board using a surface mount pick-and-place machine, and affixing the one or more transducer elements to the circuit board, each transducer element being operatively connected to the traces. The one or more transducer elements configured to receive sonar returns from an underwater environment.

In various embodiments, the traces comprise one or more sets of traces and corresponding pads. In some embodiments, each transducer element is affixed to one or more pads such that each transducer element is in electrical communication with at least one set of the one or more sets of traces. In some embodiments, each transducer element is configured to, responsive to receiving at least one sonar return, provide at least one electrical pulse via the corresponding set of traces. In various embodiments, the one or more transducer elements are mounted to the printed circuit board in an oblong shape having tapered ends. In various embodiments, the transducer elements are made of piezoelectric material. In various embodiments, the housing is configured to prevent water from contacting the printed circuit board and one or more transducer elements. In various embodiments, each transducer element is approximately 1 mm wide by 1 mm long by 0.5 mm tall. In some embodiments, the transducer assembly further comprises at least one transmitter transducer element configured to transmit at least one sonar pulse into the underwater environment.

According to another aspect of the present invention, a sonar system is provided. In various embodiments, the sonar system comprises a transducer assembly. The transducer assembly comprises a housing mountable to a watercraft and a printed circuit board (a) comprising traces, (b) having one or more transducer elements mounted thereto, and (c) positioned within the housing. The printed circuit board is prepared by a process comprising placing one or more transducer elements onto the circuit board using a surface mount pick-and-place machine, and affixing the one or more transducer elements to the circuit board. Each transducer element being operatively connected to the traces. The one or more transducer elements configured to receive sonar returns from an underwater environment.

In various embodiments, the sonar system further comprises a sonar signal processor configured to receive and process at least one sonar return signal from the transducer assembly corresponding to a received sonar return. In some embodiments, the sonar system further comprises a display configured for displaying an image of the underwater environment that is associated with the at least one sonar return signal.

Though various features of the present invention may be described as pertaining to separate embodiments, various embodiments of the present invention may incorporate multiple features described herein.

### BRIEF DESCRIPTION OF THE DRAWINGS

Having thus described the invention in general terms, reference will now be made to the accompanying drawings, which are not necessarily drawn to scale, and wherein:

FIG. 1 shows a diagram illustrating an example of a sonar transducer emitting sonar pulses;

FIG. 2 shows a basic block diagram illustrating a sonar system in accordance with some embodiments discussed herein;

FIG. 3 shows another basic block diagram illustrating a sonar system in accordance with some embodiments discussed herein;

FIG. 4 shows a diagram of a transducer assembly mounted to a boat in accordance with some embodiments discussed herein;

FIGS. 5A and 5B each show a diagram of an arrangement of transducer elements on a PCB in accordance with some embodiments discussed herein;

FIGS. 6A, 6B, and 6C show directivity plots at various frequencies for one of the diamond-shaped sub-arrays in the surface mount array illustrated in FIG. 5A;

FIG. 7 shows a flowchart of a method for manufacturing a transducer assembly according to some embodiments discussed herein; and

FIG. 8 shows a block diagram of a surface mount pick-and-place machine in accordance with some embodiments discussed herein.

### DETAILED DESCRIPTION

Exemplary embodiments of the present invention now will be described more fully hereinafter with reference to the accompanying drawings, in which some, but not all embodiments of the invention are shown. Indeed, the invention may be embodied in many different forms and should not be construed as limited to the exemplary embodiments set forth herein; rather, these embodiments are provided so that this disclosure will satisfy applicable legal requirements. Like reference numerals refer to like elements throughout.

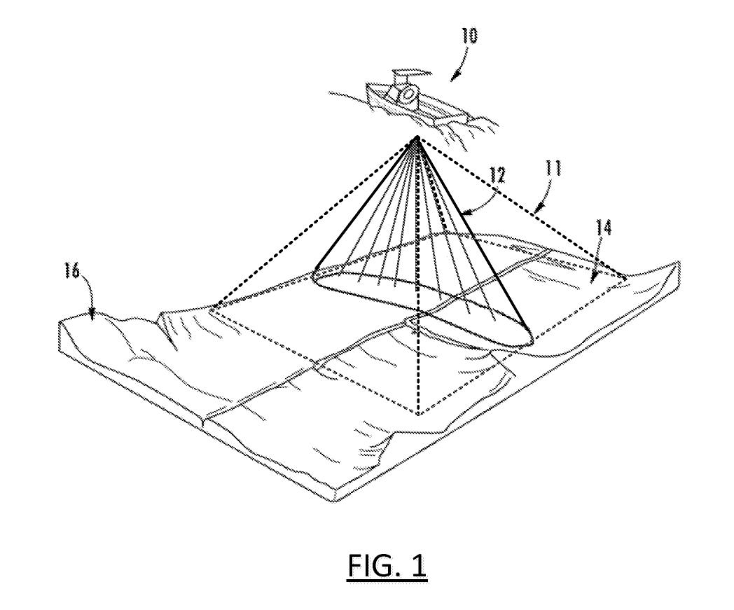

Sonar systems, such as sonar depth finders, sidescan sonars, downscan sonars, and sonar fish finders, are commonly employed by boaters, sport fishermen, search and rescue personnel, researchers, surveyors, and others. With reference to FIG. 1, a boat 10 may include a sonar system configured to create electrical pulses from a transceiver. A transducer then converts the electrical pulse into sound waves 11, which are sent into the water. In the depicted embodiment, an approximately 50° by 50° sound beam is being transmitted into the water, however, as will be apparent to one of ordinary skill in the art in view of this disclosure, other sound beam configurations (e.g., fan-shaped, conical shaped, elliptical shaped, multiple conical shaped, etc.) may be transmitted.

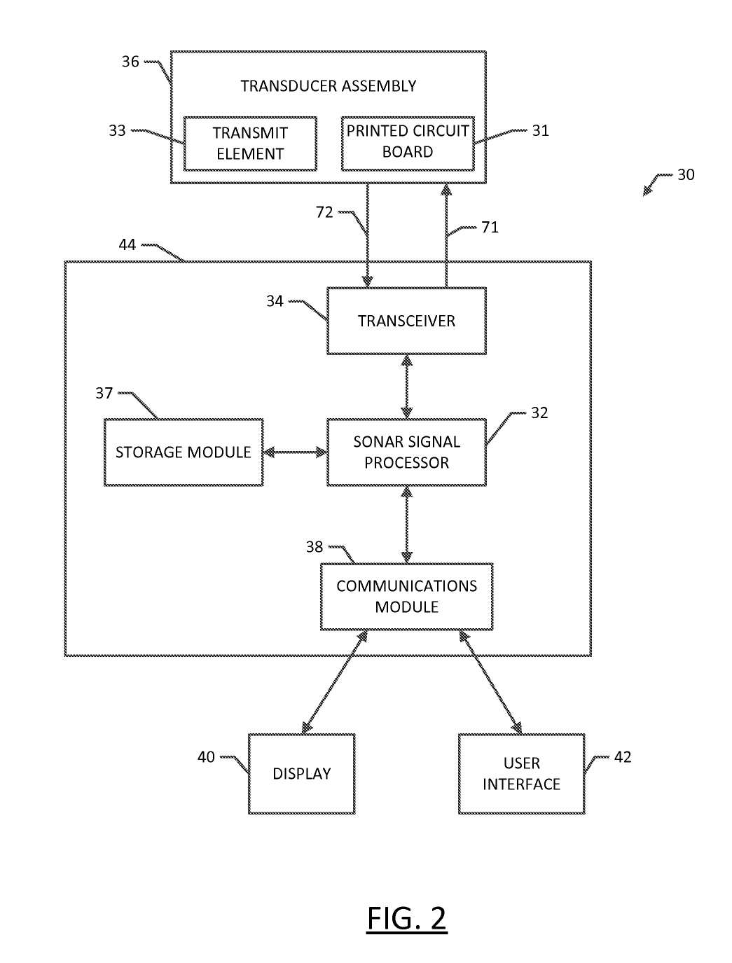

When the sound waves 11 strike anything of differing acoustic impedance (e.g., the sea floor or something suspended in the water above the bottom), the sound waves 11 reflect off that object. These echoes or sonar returns may strike the transducer or a separate receiver element, which converts the echoes back into an electrical signal which is processed by a processor (e.g., sonar signal processor 32 shown in FIG. 2) and sent to a display (e.g., an LCD) mounted in the cabin or other convenient location in the boat. This process is often called “sounding”. In various embodiments, the sonar system may be configured to “scan” the region into which the sound waves 11 were propagated. For example, the sonar system may “steer” along the track of the emitted sound beam in 1° by 50° segments, as illustrated by reception beam 12. Since the speed of sound in water may be determined by the properties of the water (approximately 4800 feet per second in fresh water), the time lapse between the transmitted signal and the received echoes can be measured and the distance to the objects determined. This process repeats itself many times per second. The results of many soundings are used to build a picture on the display of the underwater environment.

Embodiments of the present invention may include one or more transducer elements arranged to transmit and/or receive sonar signals in any orientation/direction. The active element in a given transducer may comprise at least one crystal. Wires are soldered to these coatings so that the crystal can be attached to a cable which transfers the electrical energy from the transmitter to the crystal. As an example, when the frequency of the electrical signal is the same as the mechanical resonant frequency of the crystal, the crystal moves, creating sound waves at that frequency. The shape of the crystal, shape of the array of crystals on the PCB, and the PCB determines both the resonant frequency of the array and shape of the emanated sound beam. Frequencies used by sonar devices vary but the most common ones range from 50 KHz to over 900 KHz depending on application. Some sonar systems vary the frequency within each sonar pulse using “chirp” technology. These frequencies are in the ultrasonic sound spectrum and are inaudible to humans.

### Example System Overview

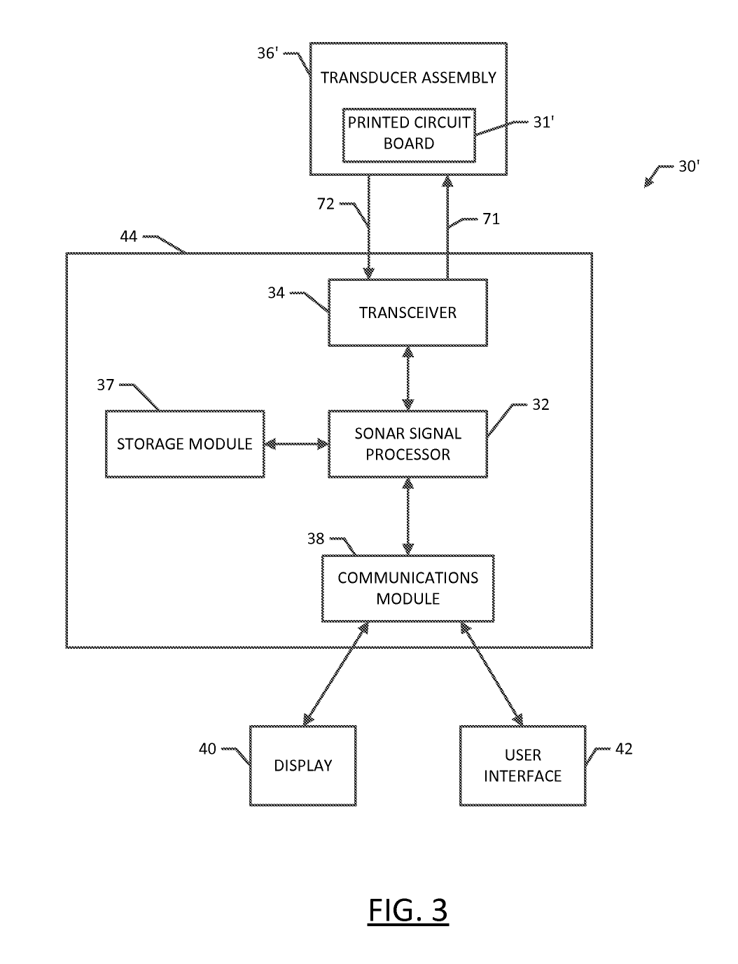

FIGS. 2 and 3 show basic block diagrams of example sonar systems 30, 30′ capable for use with several embodiments of the present invention. As shown, the sonar system 30, 30′ may include a number of different modules or components, each of which may comprise any device or means embodied in either hardware, software, or a combination of hardware and software configured to perform one or more corresponding functions. For example, the sonar system 30, 30′ may include a sonar signal processor 32, a transceiver 34, and a transducer assembly 36, 36′. The sonar system 30, 30′ may further include a storage module 37 for storing sonar return data and other data associated with the sonar system in a non-transitory computer readable medium. The sonar system 30, 30′ may also include one or more communications modules 38 configured to communicate with one another in any of a number of different manners including, for example, via a network. In this regard, the communications module 38 may include any of a number of different communication backbones or frameworks including, for example, Ethernet, the NMEA 2000 framework, GPS, cellular, WiFi, or other suitable networks. The network may also support other data sources, including GPS, autopilot, engine data, compass, radar, etc. Numerous other peripheral devices such as one or more wired or wireless multi-function displays 40 may be included in the sonar system 30, 30′.

The display 40 may be configured to display images and may include or otherwise be in communication with a user interface 42 configured to receive an input from a user. The display 40 may be, for example, a conventional LCD (liquid crystal display), a touch screen display, mobile device, or any other suitable display known in the art upon which images may be displayed. Although the display 40 of FIGS. 2 and 3 is shown as being connected to the sonar signal processor 32 via the communications module 38 (e.g., via a network and/or via an Ethernet hub), the display 40 could alternatively be in direct communication with the sonar signal processor 32 in some embodiments, or the display 40, sonar signal processor 32 and user interface 42 could be in a single housing. The user interface 42 may include, for example, a keyboard, keypad, function keys, mouse, scrolling device, input/output ports, touch screen, or any other mechanism by which a user may interface with the system. Moreover, in some cases, the user interface 42 may be a portion of one or more of the displays 40.

### Example Transducer Assembly

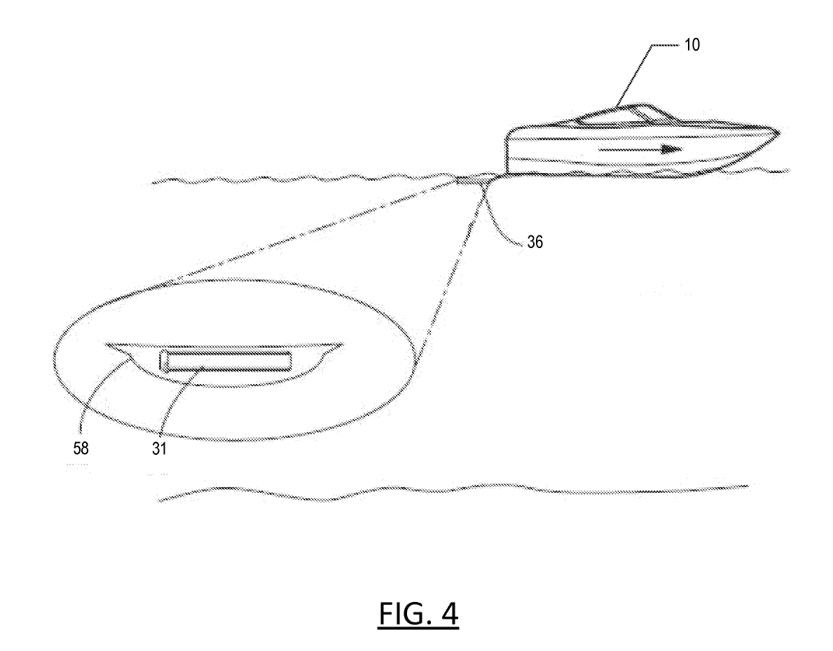

As illustrated in FIGS. 2 and 3, a sonar system 30, 30′ may comprise a transducer assembly 36, 36′. The transducer assembly 36, 36′ may comprise a housing 58 (see FIG. 4) mountable to a watercraft (e.g., boat, ship, vessel, and/or the like) 10. A printed circuit board (PCB) 31, 31′ having one or more transducer elements surface mounted thereto may be positioned within the housing 58. Each of the transducer elements may be configured to transmit one or more sonar pulses and/or receive sonar returns. In some embodiments, the one or more transducer elements may form an array (or sub-array within an array) and may be configured to transmit one or more sonar pulses and/or receive sonar returns. For example, electrical energy may be provided to one or more transducer elements causing the transducer element to vibrate and transmit a sonar pulse. In another example, a sonar return may cause one or more transducer elements to vibrate and emit an electrical output signal. For example, in response to receiving a sonar return, one or more transducer elements may provide one or more electrical pulses via a set of traces on the PCB and corresponding to the transducer element.

As noted above, one or more transducer elements (e.g., an array of transducer elements) may be surface mounted on a PCB. The PCB may be configured to mechanically support and electrically connect electronic components using conductive tracks (e.g., traces), pads, and other features. In some embodiments, the conductive tracks may comprise traces etched onto the circuit board. The conductive tracks may comprise sets of traces, for example, each transducer element may be mounted to the PCB such that the transducer element is in electrical communication with a set of traces. For example, the terminals of a transducer element may be soldered or otherwise electrically connected and mechanically secured to one or more pads of a PCB wherein each pad is in electrical communication with a trace etched onto the circuit board. For example, each transducer element may comprise one or more silver-plated terminals or other conductive material-plated terminals. Thus, each transducer element may be in electrical communication with a set of traces comprising the PCB (e.g., via the transducer element terminals). In some embodiments, other electrical elements (e.g., transceiver 34, signal processor 32, and/or the like) may be communication with the PCB having the transducer elements mounted thereto by means of connectors such as card edge connectors and/or the like.

In various embodiments, the PCB may have a fiberglass or other rigid substrate. In other embodiments, the PCB may be a flexible PCB. For example, the PCB substrate may be made of polyester (PET), polyimide (PI), polyethylene napthalate (PEN), Polyetherimide (PEI), or various fluropolymers (FEP) and copolymers Polyimide films.

As noted above, each transducer element, sub-array, and/or the array of transducer elements may be configured to transmit one or more sonar pulses and/or receive one or more sonar returns. Both transmitting a sonar pulse and receiving a sonar return requires the transducer element to be able to vibrate at least enough to convert one or more electrical pulses into a sonar pulse or to convert a sonar return into an electrical signal. In various embodiments, the vibrations of one or more transducer elements may cause the PCB to which the one or more transducer elements are mounted to vibrate. The vibration of the PCB, and possible subsequent vibration of other transducer elements mounted to the PCB may need to be taken into account in the determining of a pulse transmitted by the transducer assembly 36, 36′ or in the processing of a sonar return received by the transducer assembly 36, 36′. For example, the transducer elements mounted to the PCB 31, 31′ may be configured such that a signal may be received from each transducer element or sub-array individually. In addition to differentiating the sonar returns and/or transmission, individual wiring may enable use of processing techniques that are helpful in determining the location (e.g., polar angle coordinate) of an object/surface causing the sonar return, as will be discussed in more detail herein.

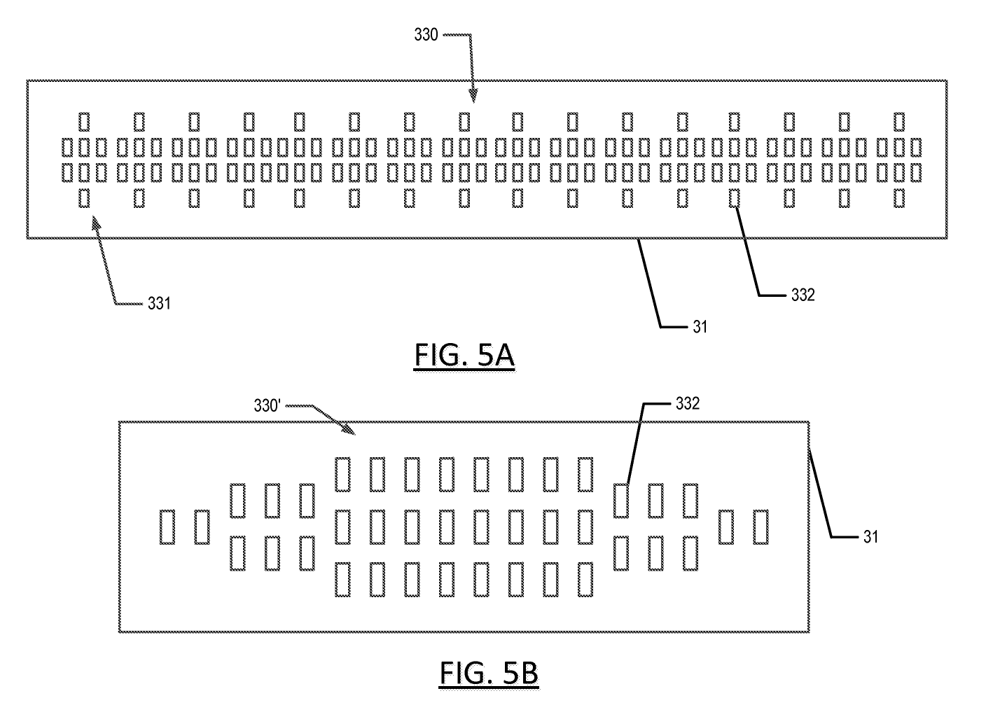

FIGS. 5A and 5B illustrate examples of transducer arrays 330, 330′ comprising transducer elements 332 mounted to a circuit board 31, 31′. In various embodiments, each of the transducer elements 332 may be substantially rectangular in shape and made from a piezoelectric material such as a piezoelectric ceramic material. While depicted and described embodiments generally detail a substantially rectangular in shape 332 made of piezoelectric material, other shapes and types of material are applicable to embodiments of the present invention. In various embodiments, each transducer element 332 may be approximately one mm by one mm. In various embodiments, each transducer element may be approximately 0.4 by 0.2 mm to 100 mm by 150 mm. In one embodiment, each transducer element is approximately 0.5 mm in height. In various embodiments, each transducer element is approximately 0.2 mm to 1 mm. In various embodiments the spacing between transducer elements 332 may be 0.25 mm or less. In other embodiments, the spacing between the transducer elements may be greater than 0.25 mm. In various embodiments, smaller or larger transducer elements 332 may be used, as appropriate for the application.

In various embodiments, the transducer array 330, 330′ may have any shape. In some embodiments, the transducer array may have a shape that would be difficult to fabricate using a single transducer element. For example, the transducer array may comprise a diamond-shaped array or two or more diamond-shaped sub-arrays 331, an oblong array having tapered ends 330′, and/or the like. FIG. 5A illustrates an example embodiment in which the transducer array comprises sixteen diamond-shaped sub-arrays 331. The diamond-shaped sub-arrays 331 are arranged such that the central axis of each of the diamond-shaped sub-arrays is parallel and/or aligned with the central axis of the other diamond-shaped sub-arrays. Each diamond-shaped sub-array 331 comprises eight transducer elements 332. FIG. 5B illustrates an example embodiment in which the transducer array 330′ comprises an oblong-shaped array with tapered ends (e.g., football-shaped). The transducer array may comprise variously shaped arrays and/or sub-arrays of transducer elements 332, as applicable for the application.

In one embodiment, the transducer array may comprise a line of two or more parallel lines of transducer elements. The beam shape and/or beam characteristics of the transducer array may be configured to approximate the beam shape and/or beam characteristics of a single ceramic element. For example, the transducer array may be configured to approximate the beam shape and/or characteristics of a single linear downscan transducer element, as described in U.S. patent application Ser. No. 13/370,633, entitled “Sonar System for Reduced Interference,” which is hereby incorporated by reference herein in its entirety. Though the above description provides an example of replacing a linear or rectangular transducer elements, other element shapes are contemplated (e.g., a conical transducer element, a square transducer element, etc.).

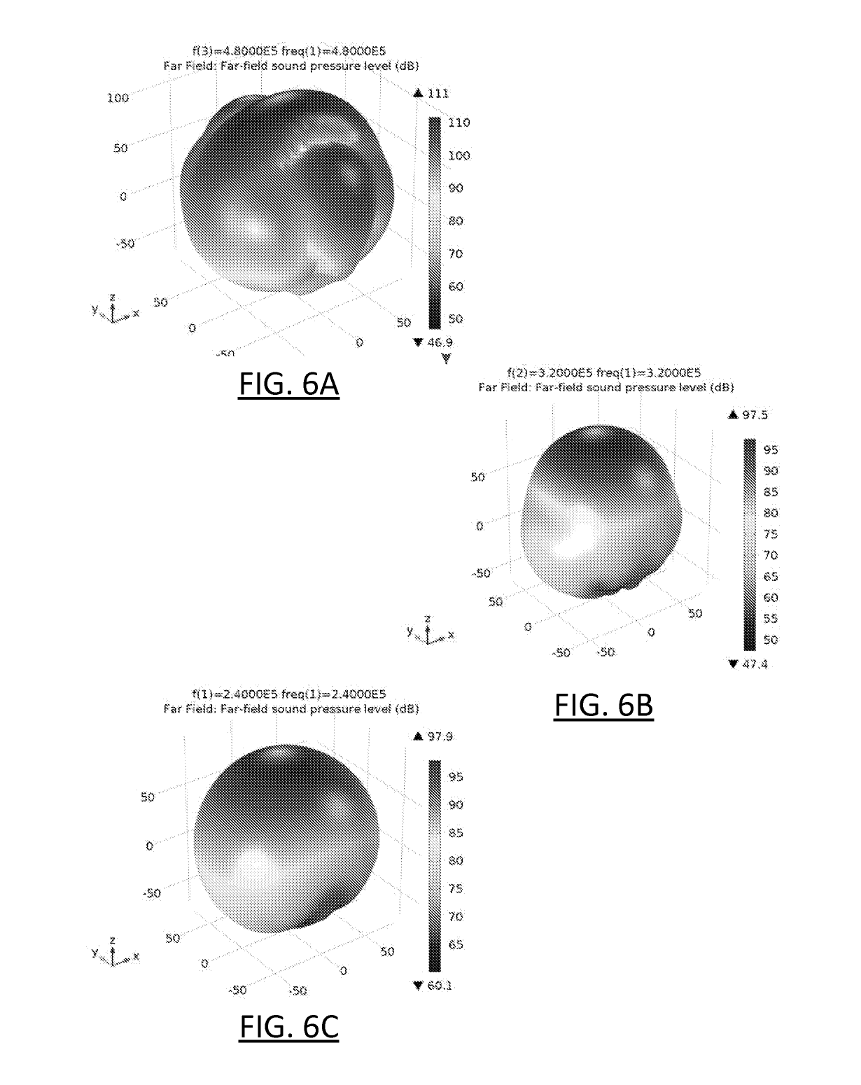

The shape of the transducer array or sub-array may affect the sonar signal transmitted by the transducer array or sub-array and the response of the transducer array or sub-array to sonar returns. FIGS. 6A, 6B, and 6C illustrate an expected far-field sound pressure level of sonar returns detectable from various angles for each diamond-shaped sub-array 331 illustrated in FIG. 5A. As shown in FIGS. 6A, 6B, and 6C, each transducer sub-array 331 shown in FIG. 5A has a field of view of approximately 50° by 50°. Other embodiments may have various other fields of view, as appropriate for the application. The response of a transducer array or sub-array may depend on the shape of that array or sub-array.

In various embodiments, the sonar system 30, 30′ may be configured to scan the field of view of the transducer array 330 (or sub-array 331). For example, the transducer array 330 may have a field of view of approximately 50° by 50°. The sonar system 30, 30′ may be configured to scan a receive beam of 1° by 50° within the 50° by 50° field of view. Such a configuration would allow for differentiation between sonar returns and enable a sonar signal processor to determine a position of sonar returns relative to each other in the steered direction.

In various embodiments the transducer array mounted on the one or more PCBs 31, 31′ may be oriented in any direction from the watercraft. For example, the transducer elements 332 mounted on the PCB 31, 31′ may be oriented down, to the left side, to the right side, forward, to the rear, among others. In some embodiments, the PCB 31, 31′ to which the transducer elements 332 are mounted may be mounted in a manner such that the orientation of the transducer array mounted to the PCB may be changed (e.g., rotated). For example, the PCB 31, 31′ may be mounted to be mechanically rotated or may be mounted on a rotatable shaft (e.g., a trolling motor).

As noted above, the PCB 31, 31′ on which the transducer array is mounted, is positioned within a housing 58. For example, the transducer assembly 36, 36′ according to an exemplary embodiment may be provided in one or more housings (e.g., the housing 58 shown in FIG. 4) that provide for flexible mounting, such as with respect to a hull of the vessel on which the sonar system 30, 30′ is employed. In this regard, for example, the housing may be mounted onto the hull of the vessel or onto a device or component (e.g., a trolling motor or other steerable device, another component that is mountable relative to the hull of the vessel, etc.), including a bracket that is adjustable on multiple axes, permitting omnidirectional movement of the housing. In various embodiments, the housing may be configured to prevent water from contacting the one or more PCBs 31, 31′, the one or more transducer elements 332, and/or other electrical component of the sonar system 30, 30′.

In various embodiments, the housing 58 may be mounted to the watercraft 10 such that the longer dimension of the PCB 31, 31′ and/or transducer array 330 is oriented along the length of the watercraft. For example, the long axis of the PCB 31, 31′ or the transducer array 330 may be parallel to the axis of the watercraft that is defined by a line connecting the bow and stern of the watercraft. In such an example, the receive beam from the transducer array 330 may define ˜1° by 50° beam pattern that may be steered in the fore-to-aft direction of the watercraft with the 50° beamwidth extending from port-to-starboard. Such a configuration would allow for processing that could differentiate between positions of sonar returns with respect to the fore-to-aft direction of the watercraft. For example, an angle with respect to a centerline extending from the center of the PCB 31, 31′ to the sonar return could be returned. Such information could be used in 2D imaging and/or 3D imaging.

Though the above described example details an orientation that utilizes beam steering to determine relative position of sonar returns in the fore-to-aft direction, other orientations and image processing techniques are contemplated with embodiments of the present invention. For example, the example PCB 31, 31′ could be oriented with its length from port-to-starboard, causing the receive beam from the transducer array 330 to define ˜1° by 50° beam pattern that may be steered in the port-to-starboard direction of the watercraft with the 50° beamwidth extending from fore-to-aft.

As previously described, in various embodiments, one or more of the transducer elements 332 may be configured to transmit at least one sonar signal into an underwater environment. In other embodiments, for example, in the embodiment shown in FIG. 2, the transducer assembly 36 may comprise a separate transmit transducer element 33 configured to transmit at least one sonar pulse into an underwater environment. In various embodiments, other components of the sonar system 30 may be mounted to the PCB. For example, one or more component of the transceiver 34 may be mounted on PCB 31.

### Manufacturing of an Example Transducer Assembly

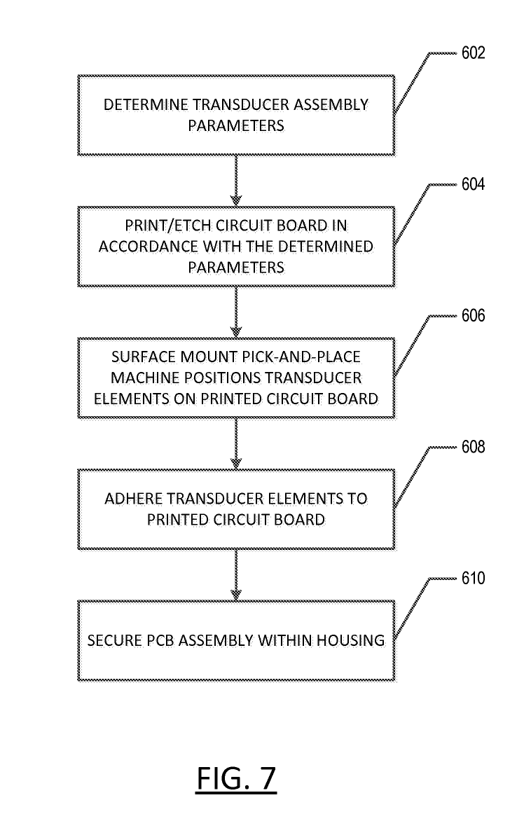

FIG. 7 provides a flowchart illustrating some processes and procedures that may be completed in the manufacture of a transducer assembly in accordance with various embodiments of the present invention. Starting at step 602, the transducer assembly parameters are determined. For example, it may be determined if the transmit transducer element(s) will be a separate element from the transducer array configured to receive sonar returns. The shape of the transducer array, the shape and electrical requirements of the transducer elements, the layout of the transducer elements on the PCB, and/or the like may be determined.

At step 604, the PCB may be printed in accordance with the determined transducer assembly parameters. For example, the conductive tracks (e.g., traces), pads, and/or the like may be formed on and/or in the PCB, as is generally known in the art. For example, pads may be formed and/or placed as appropriate for the positioning of the transducer elements in accordance with the transducer assembly parameters.

At step 606, the transducer elements are positioned on the PCB. For example, a surface mount pick-and-place machine may take one or more transducer elements from a roll of transducer elements and place each transducer element in the appropriate location on the PCB. For example, the one or more transducer elements may be positioned such that the terminals of each transducer element are appropriately positioned on a pad, and/or the like. At step 608, the one or more transducer elements are adhered to the PCB. For example, the PCB may be passed through a soldering or reflow oven and/or the like. In one embodiment, the transducer elements may be soldered by hand to the PCB. In various embodiments, the one or more transducer elements may be adhered to the PCB such that the transducer elements may receive at least one sonar return. It should be understood that a variety of methods and mechanisms may be used place and adhere the transducer elements on/to the PCB.

At step 610, the PCB, with the transducer elements adhered thereto, is positioned (e.g., secured and/or mounted) within a housing. The housing may be configured to be mounted to a water craft. The housing may also be configured to keep water from contacting the PCB, transducer elements mounted thereon, and/or other electrical elements of the transducer assembly.

### Example Surface Mount Pick-and-Place Machine

In various embodiments a surface mount technology component placement machine, also known as a surface mount pick-and-place machine, may be used in the manufacture of example transducer assemblies. The surface mount pick-and-place machine may be configured to provide high speed and high precision placement of one or more surface mount components onto a PCB. Some example surface mount pick-and-place machines are described by U.S. Pat. Nos. 5,214,841; 5,251,946; 5,564,888; 5,743,001; and 6,877,219, which are incorporated by reference herein.

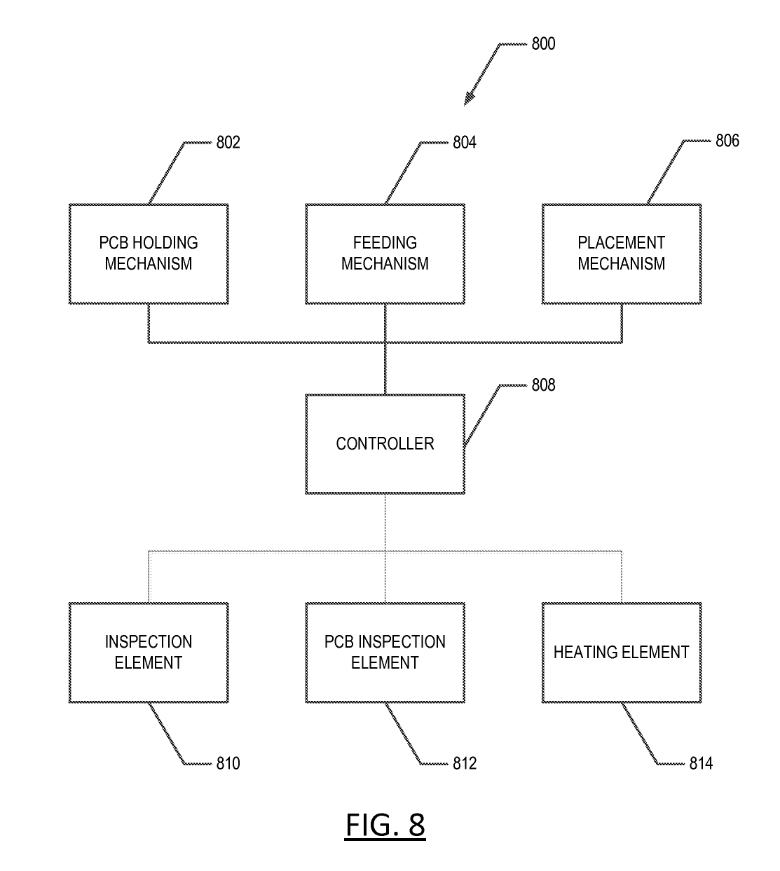

FIG. 8 provides a block diagram of an example surface mount pick-and-place machine 800. In various embodiments, the surface mount pick-and-place machine 800 comprises a PCB holding mechanism 802, a component feeding mechanism 804, a component placement mechanism 806, and a controller 808. The PCB holding mechanism 802 may be configured to hold the prepared PCB in a particular position and/or at a particular orientation such that the component placement mechanism 806 may place the one or more components onto the PCB in the specified positions and at the specified orientation. The component feeding mechanism 804 may be configured to hold a roll or reel having components thereon. For example, the component feeding mechanism 804 may hold a paper or plastic tape holding a plurality of transducer elements to be placed on one or more PCBs. The paper or plastic tape holding the components may be provided to the surface mount pick-and-place machine 800 as a roll or reel. The component placement mechanism 806 may be configured to take a component from the roll and place the component onto the PCB. For example, the component placement mechanism 806 may use suction to pick a component from the roll and place the component on the PCB. For example, the component placement mechanism 806 may comprise a pneumatic suction cup for picking up and placing the component on the PCB. The component placement mechanism 806 may be configured to place the component at a specified position (e.g., at a particular x, y, z position) on the PCB. For example, the component placement mechanism 806 may include a plotter-like device configured to precisely place the component. The controller 808 may be configured to control the PCB holding mechanism 802, the component feeding mechanism 804, and the component placing mechanism 806. For example, the controller 808 may comprise a processor and/or memory configured to control the PCB holding mechanism 802, the component feeding mechanism 804, and the component placement mechanism 806 to quickly and precisely place one or more components on the PCB. In various embodiments, the pick-and-place machine 800 may include multiple component feeding mechanisms 804 and multiple component placing mechanisms 806, each for feeding/placing one or more components onto the PCB.

In various embodiments, the surface mount pick-and-place machine 800 may further comprise one or more inspection elements 810 configured to image the PCB, a component the component placement mechanism 806 has picked up from the roll of components, and/or the like to provide feedback to the controller 808. For example, if the component placement mechanism 806 picked up the component in an orientation that is slightly rotated from the expected orientation, image data captured by the inspection element 810 may be used by the controller 808 to determine the correction required to place the component in the specified position and at the specified orientation. In various embodiments, the surface mount pick-and-place machine 800 may comprise a PCB inspection element 812 configured to capture image data regarding the position of the PCB held by the PCB holding mechanism 802. The image data captured by the PCB inspection element 812 may be used by the controller 808 in controlling the component placement mechanism 806 in placing the component in the specified position at the specified orientation on the PCB. For example, the PCB may comprise two fiducial marks and the controller 808 may be configured to identify the fiducial marks in the image data captured by the PCB inspection element 812 such that the component placement mechanism 806 may place the component in the appropriate position on the PCB relative to the fiducial marks and/or by taking the location and orientation of the fiducial marks into account.

In some embodiments, the surface mount pick-and-place machine 800 may further include a heating mechanism 814 configured to affix the placed components to the PCB. For example, the heating mechanism 814 may be configured to provide heat to cause the solder pads on the PCB to soften and affix to the terminals of the components placed thereon. In other embodiments, a reflow oven and/or the like may be used to affix the placed components to the PCB.

In various embodiments, the size of the transducer elements mounted to the PCB is restricted by the component size and weight restrictions of the surface mount pick-and-place machine 800. For example, the weight of the transducer element may be restricted by the maximum weight the component placement device 806 can pick up. In another example, the size of the transducer element may be restricted by the maximum component size the component feeding mechanism 804 can provide to the pick-and-place machine 800 and/or the maximum component size the component placement mechanism 806 can pick up and place on the PCB. For example, the transducer elements may have a maximum size of 100 mm by 150 mm. In various embodiments, the minimum spacing between two transducer elements mounted on the PCB may be defined by the minimum lead pitch of the surface mount pick-and-place machine 800. For example, the spacing between adjacent transducer elements may be 0.3 mm or more. In another example, the spacing between adjacent transducer elements may be 0.25 mm or less.

### Example Sonar Processing

The following describes various example embodiments for transforming and rendering raw sonar data in different contexts, which may be performed by the sonar systems 30, 30′, through the configuration of the sonar module 44. It is understood that the sonar systems 30, 30′ described herein are merely examples of computing systems that may be configured to perform the various functionalities. For example, computing systems that are not configured for mounting to a watercraft and do not have interfaces to sonar transducer elements may be configured to perform at least some of the functionality described herein. Additionally, it will be apparent to one of skill in the art that the following described functionalities may be performed together in a unified manner or as separate, independent functions where appropriate.

As detailed herein, embodiments of the transducer assembly 36, 36′ may be configured to receive sonar returns from substantially the same area of the underwater environment using one or more transducer elements 332. The output of the one or more transducer elements 332 may be used to determine a position of the reflecting object/surface from which the received returns originated by comparing the respective returns received at each element.

While some embodiments illustrate outputs with respect to one type of transducer array (e.g., series of diamond-shaped sub-arrays), any type of array (e.g., football-shaped or other shaped arrays or sub-arrays) may produce similar results unless otherwise indicated. For example, an array or sub-array may be shaped to help reduce the side lobes of the beam provided by the array or sub-array.

The sonar module 44 (e.g., signal processor 32) may be configured to process output from one or more transducer elements, sub-arrays, or arrays. A variety of signal processing methods may be used as appropriate for the application. For example, interferometry, beam steering, and other methods of signal processing may be used. U.S. Patent Application No. 62/128,635, entitled “Systems And Associated Methods For Producing A 3D Sonar Image” provides additional detail regarding various methods of signal processing and is hereby incorporated by reference herein in its entirety.

For example, the time between when the sonar pulse is transmitted and the sonar return is received may be used to determine the distance from the transducer assembly 36, 36′ to the reflecting object/surface. In some embodiments, the order and timing of the sonar return being received by the transducer elements 332 or sub-arrays 331 along with known spacing between the elements or beam forming techniques may be used to determine the angle at which the reflecting object/surface is located relative to the transducer assembly 36, 36′. For example, the relative travel time of the sonar return received by a first transducer element or sub-array and the sonar return received by a second transducer element or sub-array may be used to determine the angle of the reflecting object/surface with respect to the transducer assembly 36, 36′. In this way, the location of the reflecting object/surface relative to the transducer assembly (and the boat, ship, etc.) may be determined.

### Example Display and Imaging

In any of the embodiments detailed above, a display (e.g., the display 40 of the sonar system 30 shown in FIG. 2) may present one or more sets of data. In various embodiments, the sonar module 44 may provide an image to be displayed via display 40. The image may be a 2D or 3D image, as appropriate for the application. Combinations of any of the above-referenced sets of data, in addition to chart information, radar, weather, or any other type of information relevant to watercraft, may be presented simultaneously on the display (e.g., via split screen). A user may select any of the possible combinations of display, or a sonar system may update the display based on a desired mode or the characteristics of the boat's motion. For example, the sonar system may automatically add a split-screen view of a downscan sonar image when a boat is idling or an engine is shut off (e.g., when trolling).

In some further embodiments, various sets of data, referred to above, may be superimposed or overlaid onto one another. For example, the image may be applied to chart information (e.g., a map or navigational chart). Additionally or alternatively, depth information, weather information, radar information, or any other sonar system inputs may be applied to one another. For example, weather or radar information may be added above the boat in the image.

### Example System Hardware

In some embodiments, referring back to FIGS. 2 and 3, the transducer assembly may include a housing (e.g., the housing 58 shown in FIG. 4) that may include mounting holes through which screws, rivets, bolts or other mounting devices may be passed in order to fix the housing 58 to a mounting bracket, a device attached to a vessel or to the hull of the vessel itself. However, in some cases, the housing may be affixed by welding, adhesive, snap fit or other coupling means. The housing may be mounted to a portion of the vessel, or to a device attached to the vessel, that provides a relatively unobstructed view of both sides of the vessel, below the vessel, and/or the like. Thus, for example, the housing 58 may be mounted on or near the keel (or centerline) of the vessel, on a fixed or adjustable mounting bracket that extends below a depth of the keel (or centerline) of the vessel, or on a mounting device that is offset from the bow or stern of the vessel. In some embodiments, the sonar module (e.g., the sonar module 44 of FIGS. 2 and 3) may have one or more components, such as the sonar signal processor 32, positioned within the housing. For example, in various embodiments one or more elements of the sonar module 44 may be a part of the transducer assembly 36, 36′. For example, in one embodiment, all of the components of the sonar module 44 (e.g., sonar signal processor 32, transceiver 34, storage module 37, and communications interface 38) may be a part of the transducer assembly 36, 36′.

With reference to FIG. 4, the housing 58 may include a recessed portion defining containment volume for holding the transducer assembly components. The recessed portion defining the containment volume may extend away from the hull of the vessel on which the housing 58 is mounted and therefore protrude into the water on which the vessel operates (or in which the vessel operates in a case where the transducer assembly is mounted to a tow fish or other submersible device). To prevent cavitation or the production of bubbles due to uneven flow over the housing 58, the housing 58 (and in particular the containment volume portion of the housing) may have a gradual, rounded or otherwise streamlined profile to permit laminar flow of water over the housing 58. In some examples, an insulated cable may provide a conduit for wiring (e.g., transmitter circuitry 71 or receiver circuitry 72) to couple the elements of the transducer assembly (e.g., 33, 31, 31′) to the sonar module 44. As detailed herein, any of a number of configurations of transducer elements and transducer arrays may be provided within the housing 58.

The shape of a transducer array, sub-array, or element may largely determine the type of beam that is formed when that transducer array, sub-array, or element transmits a sonar pulse (e.g., a circular transducer array, sub-array, or element emits a cone-shaped beam, a linear transducer emits a fan-shaped beam, etc.). In some embodiments, an array or sub-array may comprise one or more transducer elements positioned to form/act as one transducer element. For example, a linear transducer array may comprise two or more rectangular transducer elements aligned with each other so as to be collinear. In some embodiments, three transducer elements aligned in a collinear fashion (e.g., end to end) may define one linear transducer array.

Likewise, transducer elements may comprise different types of materials that cause different sonar pulse properties upon transmission. For example, the type of material may determine the strength of the sonar pulse. Additionally, the type of material may affect the sonar returns received by the transducer element. As such, embodiments of the present invention are not meant to limit the shape or material of the transducer elements. Indeed, while depicted and described embodiments generally detail a linear transducer element made of piezoelectric material, other shapes and types of material are applicable to embodiments of the present invention.

As noted above, any of the transducer elements, sub-arrays, or arrays described herein may be configured to transmit and receive sonar pulses (e.g., transmit/receive transducer elements). While the transducer elements, sub-arrays, or arrays may be described herein as transmit/receive transducer elements, in some embodiments, the transducer elements, sub-arrays, or arrays may be configured as receive-only transducer elements, sub-arrays, or arrays, or in other cases, transmit-only transducer elements, sub-arrays, or arrays. In various embodiments, the power of the beam that may be transmitted by the transducer elements surface mounted to the PCB 31′ may be restricted by the ability of the solder to mechanically affix the vibrating transducer elements to the PCB 31′.

The transducer elements can convert electrical energy into sound energy (i.e., transmit) and also convert sound energy (e.g., via detected pressure changes) into an electrical signal (i.e., receive), although some transducers may act only as a hydrophone for converting sound energy into an electrical signal without operating as a transmitter, or only operating to convert an electrical signal into sound energy without operating as a receiver. Depending on the desired operation of the transducer assembly, each of the transducer elements may be configured to transmit sonar pulses and/or receive sonar returns as desired. In some embodiments, the transducer assembly 36, 36′ may comprise a combination of transducer elements, sub-arrays, and/or arrays that are configured to transmit sonar pulses and receive sonar returns, transducer elements sub-arrays, and/or arrays that are configured to transmit sonar pulses only, and/or transducer elements sub-arrays, and/or arrays that are configured to receive sonar returns only.

In an example embodiment, the sonar signal processor 32, the transceiver 34, the storage module 37 and/or the communications module 38 may form a sonar module 44. As such, for example, in some cases, the transducer assembly 36, 36′ may simply be placed into communication with the sonar module 44, which may itself be a mobile device that may be placed (but not necessarily mounted in a fixed arrangement) in the vessel to permit easy installation of one or more displays 40, each of which may be remotely located from each other and operable independent of each other. In this regard, for example, the communications module 38 may include one or more corresponding interface ports for placing the network in communication with each display 40 in a plug-n-play manner. As such, for example, the communications module 38 may not only include the hardware needed to enable the displays 40 to be plugged into communication with the network via the communications module, but the communications module 38 may also include or otherwise be in communication with software modules for providing information to enable the sonar module 44 to communicate with one or more different instances of the display 40 that may or may not be the same model or type of display and that may display the same or different information. In other words, the sonar module 44 may store configuration settings defining a predefined set of display types with which the sonar module is compatible so that if any of the predefined set of display types are placed into communication with the sonar module 44, the sonar module 44 may operate in a plug-n-play manner with the corresponding display types. Accordingly, the sonar module 44 may include the storage device 37 storing device drivers accessible to the communications module 38 to enable the sonar module 44 to properly work with displays for which the sonar module 44 is compatible. The sonar module 44 may also be enabled to be upgraded with additional device drivers or transceivers to enable expansion of the numbers and types of devices with which the sonar module 44 may be compatible. In some cases, the user may select a display type to check whether a display type is supported and, if the display type is not supported, contact a network entity to request software and/or drivers for enabling support of the corresponding display type.

The sonar signal processor 32 may be any means such as a device or circuitry operating in accordance with software or otherwise embodied in hardware or a combination of hardware and software (e.g., a processor operating under software control or the processor embodied as an application specific integrated circuit (ASIC) or field programmable gate array (FPGA) specifically configured to perform the operations described herein, or a combination thereof) thereby configuring the device or circuitry to perform the corresponding functions of the sonar signal processor 32 as described herein. In this regard, the sonar signal processor 32 may be configured to analyze electrical signals communicated thereto by the transceiver 34 to provide sonar data indicative of the size, location, shape, etc. of objects detected by the sonar system 30, 30′. For example, the sonar signal processor 32 may be configured to receive sonar return data and process the sonar return data to generate sonar image data for display to a user (e.g., on display 40). Moreover, in some embodiments, the sonar signal processor 32 may be configured to receive downscan sonar return data and sidescan sonar return data for processing and generation of sonar image data for display to a user.

In some cases, the sonar signal processor 32 may include a processor, a processing element, a coprocessor, a controller or various other processing means or devices including integrated circuits such as, for example, an ASIC, FPGA or hardware accelerator, that is configured to execute various programmed operations or instructions stored in a memory device. The sonar signal processor 32 may further or alternatively embody multiple compatible additional hardware or hardware and software items to implement signal processing or enhancement features to improve the display characteristics or data or images, collect or process additional data, such as time, temperature, GPS information, waypoint designations, or others, or may filter extraneous data to better analyze the collected data. It may further implement notices and alarms, such as those determined or adjusted by a user, to reflect depth, presence of fish, proximity of other watercraft, etc. Still further, the processor, in combination with the storage module 37, may store incoming transducer data or screen images for future playback or transfer, or alter images with additional processing to implement zoom or lateral movement, or to correlate data, such as fish or bottom features to a GPS position or temperature. In an exemplary embodiment, the sonar signal processor 32 may execute commercially available software for controlling the transceiver 34 and/or transducer assembly 36, 36′ and for processing data received therefrom.

The transceiver 34 may be any means such as a device or circuitry operating in accordance with software or otherwise embodied in hardware or a combination of hardware and software (e.g., a processor operating under software control or the processor embodied as an ASIC or FPGA specifically configured to perform the operations described herein, or a combination thereof) thereby configuring the device or circuitry to perform the corresponding functions of the transceiver 34 as described herein. In this regard, for example, the transceiver 34 may include (or be in communication with) circuitry (e.g., transmitter circuitry 71 shown in FIGS. 2 and 3) for providing one or more transmission electrical signals to the transducer assembly 36, 36′ for conversion to sound pressure signals based on the provided electrical signals to be transmitted as a sonar pulse. The transceiver 34 may also include (or be in communication with) circuitry (e.g., receiver circuitry 72 shown in FIGS. 2 and 3) for receiving one or more electrical signals produced by the transducer assembly 36, 36′ responsive to sound pressure signals received at the transducer assembly 36, 36′ based on echo or other return signals received in response to the transmission of a sonar pulse. The transceiver 34 may be in communication with the sonar signal processor 32 to both receive instructions regarding the transmission of sonar signals and to provide information on sonar returns to the sonar signal processor 32 for analysis and ultimately for driving one or more of the displays 40 based on the sonar returns. In some embodiments, the transmitter circuitry 71 and/or receiver circuitry 72 may be positioned within the transceiver 34 or sonar module 44. In other embodiments the transmitter circuitry 71 and/or receiver circuitry 72 may be positioned within the transducer assembly 36. Likewise, in some embodiments, the transmitter circuitry 71 and/or receiver circuitry 72 may be positioned separate from the transducer assembly 36, 36′ and transceiver 34/sonar module 44.

Many modifications and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

1. A method for manufacturing a transducer assembly, the method comprising:
placing one or more transducer elements onto a circuit board using a surface mount pick-and-place machine; and
affixing the one or more transducer elements to the circuit board, each transducer element being operatively connected to traces etched to the circuit board;
wherein each transducer element is configured to receive sonar returns from an underwater environment.

2. The method of claim 1 wherein the affixing of the one or more transducer elements to the circuit board is accomplished by a reflow oven.

3. The method of claim 1 wherein each of the transducer elements are 150 mm by 100 mm or smaller.

4. The method of claim 1 wherein placing each of the one or more transducer elements onto the circuit board using the surface mount pick-and-place machine comprises:
providing a tape reel of transducer elements to the surface mount pick-and-place machine;
removing a transducer element from the tape reel using a component placement mechanism of the surface mount pick-and-place machine; and
placing the transducer element onto the PCB using the component placement mechanism of the surface mount pick-and-place machine such that the terminals of the transducer element rest on pads of the PCB.

5. The method of claim 4 wherein to remove the transducer element from the tape reel the component placement mechanism applies suction to the transducer element and to place the transducer element onto the PCB the component placement mechanism releases the suction.

6. The method of claim 1 wherein each of the transducer elements is placed on the PCB in accordance with a specified x, y, z position.

7. The method of claim 1 wherein the one or more transducer elements are placed on the PCB to form one line or more than one parallel lines in order to approximate the shape or beam pattern characteristics of a single ceramic element.

8. The method of claim 1 wherein the traces comprise one or more sets of traces and each transducer element is affixed to one or more pads such that each transducer element is in electrical communication with at least one set of the one or more sets of traces.

9. The method of claim 1 wherein affixing the one or more transducer elements to the circuit board comprises affixing the one or more transducer elements to the printed circuit board in one or more diamond shapes.

10. The method of claim 9 wherein affixing the one or more transducer elements to the printed circuit board comprises affixing the one or more transducer elements in 16 diamond shapes positioned such that a central axis of each diamond is substantially aligned with the central axis of each of the other diamonds.

11. The method of claim 1 wherein the printed circuit board is a flexible printed circuit board.

12. The method of claim 1 wherein each transducer element is electrically connected to individually receive the sonar returns.

13. A transducer assembly comprising:
a housing mountable to a watercraft;
a printed circuit board (a) comprising traces, (b) having one or more transducer elements mounted thereto, and (c) positioned within the housing, the printed circuit board prepared by a process comprising:
placing one or more transducer elements onto the circuit board using a surface mount pick-and-place machine, and
affixing the one or more transducer elements to the circuit board, each transducer element being operatively connected to the traces, the one or more transducer elements configured to receive sonar returns from an underwater environment.

14. The transducer assembly of claim 13 wherein the one or more transducer elements are mounted to the printed circuit board in one or more diamond shapes.

15. The transducer assembly of claim 14 wherein the one or more transducer elements are mounted to the printed circuit board in 16 diamond shapes positioned such that a central axis of each diamond is substantially aligned with the central axis of each of the other diamonds.

16. The transducer assembly of claim 14 wherein each diamond shape comprises 8 transducer elements.

17. The transducer assembly of claim 13 wherein the one or more transducer elements are mounted to the printed circuit board in an oblong shape having tapered ends.

18. The transducer assembly of claim 13 wherein the transducer elements are made of piezoelectric material.

19. The transducer assembly of claim 13 wherein the housing is configured to prevent water from contacting the printed circuit board and one or more transducer elements.

20. The transducer assembly of claim 13 wherein the printed circuit board is a flexible printed circuit board.

21. The transducer assembly of claim 13 wherein each transducer element is electrically connected to individually receive the sonar returns.

22. The transducer assembly of claim 13 wherein each transducer element is approximately 1 mm wide by 1 mm long by 0.5 mm tall.

23. The transducer assembly of claim 13 wherein each transducer element is approximately 150 mm by 100 mm or smaller.

24. The transducer assembly of claim 13 further comprising at least one transmitter transducer element configured to transmit at least one sonar pulse into the underwater environment.

25. A sonar system comprising:
a transducer assembly, the transducer assembly comprising:
a housing mountable to a watercraft;
a printed circuit board (a) comprising traces, (b) having one or more transducer elements mounted thereto, and (c) positioned within the housing, the printed circuit board prepared by a process comprising:
placing one or more transducer elements onto the circuit board using a surface mount pick-and-place machine, and
affixing the one or more transducer elements to the circuit board, each transducer element being operatively connected to the traces;
the one or more transducer elements configured to receive sonar returns from an underwater environment.

26. The sonar system of claim 25 further comprising:
a sonar signal processor configured to receive and process at least one sonar return signal from the transducer assembly corresponding to a received sonar return.

27. The sonar system of claim 25 further comprising:
a display configured for displaying an image of the underwater environment that is associated with the at least one sonar return signal.

28. The sonar system of claim 25 wherein the one or more transducer elements are mounted to the printed circuit board in one or more diamond shapes.

29. The sonar system of claim 28 wherein the one or more transducer elements are mounted to the printed circuit board in 16 diamond shapes positioned such that a central axis of each diamond is substantially aligned with the central axis of each of the other diamonds.

30. The sonar system of claim 25 wherein the printed circuit board is a flexible printed circuit board.

31. The sonar system of claim 25 wherein each transducer element is electrically connected to individually receive the sonar returns.

32. The sonar system of claim 25 further comprising at least one transmitter transducer element configured to transmit at least one sonar pulse into an underwater environment.

33. The sonar system of claim 25, wherein at least one of the one or more transducer elements is configured to transmit at least one sonar pulse into the underwater environment.
